(19) United States
(12) Patent Application Publication
(10) Pub. No.: US 2013/0092540 A1
(43) Pub. Date: Apr. 18, 2013

(54) ELECTRODEIONIZATION ELECTRODE CHAMBER CONFIGURATION FOR ENHANCING HARDNESS TOLERANCE

(71) Applicant: John H. Barber, Guelph (CA)

(72) Inventor: John H. Barber, Guelph (CA)

(73) Assignee: GENERAL ELECTRIC COMPANY, Schenectady, NY (US)

(21) Appl. No.: 13/273,884

(22) Filed: Oct. 14, 2011

(51) Int. Cl. B01D 61/48; B01D 61/44

(52) U.S. Cl. 204/533; 204/632

(57) ABSTRACT

An electrodeionization stack for deionizing a feed solution. The electrodeionization stack includes a recirculating system adapted to flow an acidic anode effluent solution into a cathode compartment. The anode compartment, may have a three-layer ion exchange resin stack, the three-layer ion exchange resin stack being made up of a layer of cation exchange resin, a layer of anion exchange resin, and a mixed bed ion-exchange resin located between the cation and the anion exchange resins. The cathode compartment may have anion exchange resins adjacent the cathode and a mixed bed ion exchange resins.

### FIELD

The present disclosure relates to electrodeionization devices.

### BACKGROUND

Electrodeionization (EDI) is a water treatment method which uses an applied electric potential difference to ionize water molecules and transport ions from one solution, through ion-exchange membranes, to another solution. EDI is used to separate dissolved ions from a feed water. The feed water may be, for example, permeate from a reverse osmosis (RO) unit.

EDI is typically performed using an electrodeionization stack. An electrodeionization stack includes alternating anion and cation-exchange membranes placed between two electrodes, an anode and a cathode. The membranes create alternating purifying (or deionizing) compartments and concentrating compartments. Mixed or separated bed ion-exchange resin beads are located between the membranes at least in the purifying compartments. The feed solution flows through both sets of compartments. The purifying compartments typically operate with once-through flow whereas the concentrating compartments can operate in either once-through or in a re-circulating flow pattern. Some ions in the concentrating compartments are those removed from the feed water by the ion-exchange resins in the purifying compartments, others are from the water splitting process. The applied electric potential difference causes water splitting which generate hydrogen and hydroxide ions which regenerate the ion exchange resins. The electric potential also causes ion migration which transfers cations towards the cathode and anions towards the anode. Ions that move out of the purifying compartments become trapped in adjacent concentrating compartments. A bleed or discharge of ion concentrated effluent is taken from the water flowing through the concentrating compartments. Ion-reduced product water is discharged from the outlets of the purifying compartments.

The EDI process beneficially provides deionization without requiring chemicals to regenerate the ion exchange resins. However, EDI equipment is prone to scaling. In particular, hydroxide ions generated at the cathode react with hardness in the feed water to form a scale in the cathode compartment. This hardness scale restricts both the flow of electrical current through the stack and the fluid flow through the cathode compartment. Attempts to control this scaling have included injecting acid into the cathode compartment and increasing the rate of flow through the cathode compartment. Neither of these attempts have proven acceptable in the field. For this reason, EDI equipment is often not able to treat single pass RO permeate without additional treatments. The first pass RO permeate may be treated in a second RO pass, through electrodialyis, or by sodium cycle ion exchange resins. Improving the scaling resistance of EDI electrodes would beneficially reduce the need for these additional treatments.

### INTRODUCTION TO THE INVENTION

The following discussion is intended to introduce the reader to the detailed discussion to follow, and not to limit any claimed invention. A claimed invention may relate to a sub-combination of elements or steps described below, or to a combination of one or more elements or steps described below with an element or step described in other parts of this specification.

This specification describes electrode configurations for an EDI device. In particular, electrode configurations are described in which ion exchange resins are provided in the electrode compartment. Configurations for adjacent concentrating compartments are also described, as well as flow pattern configurations through the device. In particular, a flow pattern configuration is described in which hydrogen ions or acid generated at the anode are used to neutralize hydroxide ions or bases in the cathode. Alone or in various combinations, these configurations resist the formation of hardness scale in cathode compartment of the EDI device.

One electrodeionization stack includes: a cathode and an anode; a first ion exchange membrane and a second ion exchange membrane, the first and second ion exchange membranes having a deionizing and a salt concentrating compartment between them; ion exchange resins located in the deionizing compartment; a cathode compartment located between the first ion exchange membrane and the cathode and adapted to accept a cathode feed solution and dispense a cathode effluent solution; an anode compartment located between the second ion exchange membrane and the anode and adapted to accept an anode feed solution and dispense an acidic anode effluent solution; a flow path adapted to flow the acidic anode effluent solution into the cathode feed solution; the deionizing compartment adapted to accept a feed solution and dispense a deionized effluent on application of an applied electric potential difference.

The first ion exchange membrane may be a cation exchange membrane and the second ion exchange membrane may be an anion exchange membrane. The second ion exchange membrane, or an intermediate anion exchange membrane forming a neutral compartment with the second ion exchange membrane, retains cations in the anode compartment. The retained cations may be H⁺ ions.

The electrodeionization stack may further include a first three-layer ion exchange resin stack positioned in the anode compartment; wherein the three-layer ion exchange resin stack is made up of a layer of cation exchange resin, a layer of anion exchange resin, and a mixed bed ion-exchange resin located between the cation and the anion exchange resins; and wherein the three-layer exchange resin stack is positioned with the cation exchange resin on the anode side, and the anion exchange resin on the cathode side.

The electrodeionization stack may further include a second three-layer ion exchange resin stack positioned in the cathode compartment; wherein the three-layer ion exchange resin stack is made up of a layer of cation exchange resin, a layer of anion exchange resin, and a mixed bed ion-exchange resin located between the cation and the anion exchange resins; and wherein the three-layer exchange resin stack is positioned with the cation exchange resin on the anode side, and the anion exchange resin on the cathode side. Alternatively, the electrodeionization stack may include a two-layer ion exchange resin stack positioned in the cathode compartment; wherein the two-layer ion exchange resin stack is made up of a layer of anion exchange resin, and a layer of mixed bed ion-exchange resin, wherein the two-layer exchange resin stack is positioned with the anion exchange resin on the cathode side of the mixed bed ion-exchange resin.

The electrodeionization stack may further include a third ion exchange membrane positioned on the cathode side of the second ion exchange membrane, the second and third ion exchange membranes defining a first neutral compartment which is adapted to carry a flow of feed or salt-concentrating solution. The second and third ion exchange membranes may both be anion exchange membranes. The first neutral compartment may include anion exchange resin or mixed bed ion-exchange resin.

The electrodeionization stack may further include a fourth ion exchange membrane positioned on the anode side of the first ion exchange membrane, the first and fourth ion exchange membranes defining a second neutral compartment which is adapted to carry a flow of neutral compartment solution, which may be the same at the feed solution, or as the salt-concentrating solution, where the feed solution and the salt-concentrating solutions may be the same. The first and fourth ion exchange membranes may both be cation exchange membranes.

The second neutral compartment may include cation exchange resin or mixed bed ion-exchange resin. Alternatively, the second neutral compartment may include mixed bed ion-exchange resin and the second neutral compartment further comprises cation exchange resin located on the cathode side of the fourth ion exchange membrane.

One method of producing a deionized effluent from a feed solution which comprises anions and cations includes: providing the feed solution to a deionizing compartment of an electrodeionizing stack, the electrodeionizing stack comprising an anode and a cathode; providing an anode feed solution to an anode compartment of the electrodeionizing stack; providing a cathode feed solution to a cathode compartment of the electrodeionizing stack; applying an electric potential difference across the electrodeionizing stack to: (i) induce the cations in the feed solution to move through a first ion exchange membrane towards the cathode, and induce the anions in the feed solution to move through a second ion exchange membrane towards the anode, thereby producing the deionized effluent; and (ii) generate H⁺ ions in the anode compartment; dispensing the deionized effluent from the deionizing compartment; dispensing an anode effluent solution from the anode compartment; and directing at least a portion of the anode effluent solution into the electrodeionizing stack as the cathode feed solution, or as a mixture with the cathode feed solution.

The H+ ions generated in the anode compartment may be retained in the anode compartment by the second ion exchange membrane or an intervening ion exchange membrane forming a neutral compartment with the second ion exchange membrane.

The cations may be inhibited from migrating towards the cathode by the presence of anion exchange resin in the cathode compartment. Inhibiting the cations from migrating may concentrate the cations in an area of the cathode compartment which has a greater flow rate than the flow rate adjacent to the cathode.

The anions may be inhibited from migrating towards the anode by the presence of cation exchange resin in the anode compartment. Inhibiting the anions from migrating may concentrate the anions in an area of the anode compartment which has a greater flow rate than the flow rate adjacent to the anode.

At least a portion of the cations may be divalent cations.

### BRIEF DESCRIPTION OF THE DRAWINGS

FIG. 1 is a schematic illustrating a traditional electrodeionization stack.

FIG. 2 is a schematic illustrating an electrodeionization stack having anode and cathode compartments containing ion exchange resins and modified compartments adjacent to the anode and cathode compartments.

FIG. 3A is a schematic illustrating an electrodeionization stack having anode and cathode compartments with multiple layers of ion exchange resins.

FIG. 3B is a schematic illustrating a variant of the electrodeionization stack illustrated in FIG. 3A.

FIG. 4A is a schematic illustrating an electrodeionization stack having anode and cathode compartments with multiple layers of ion exchange resins and neutral compartments adjacent the anode and cathode compartments.

FIG. 4B is a schematic illustrating a variant of the electrodeionization stack illustrated in FIG. 4A.

### DETAILED DESCRIPTION

In the present disclosure, electrodeionization stacks are discussed as including anion exchange resins, cation exchange resins, mixed-bed ion exchange resins, or combinations thereof. Although the discussion of the electrodeionization stacks refers to “resins”, it should be understood that other ion exchange materials could be used instead, for example zeolites.

The ion exchange materials (for example the cation exchange resins, the anion exchange resins, and the mixed bed ion-exchange resins) may be of any shape or configuration known in the art. For example, the resins may be particles of any shape, such as spherical particles. In another example, the resins may be fibres, perforated sheets or fabrics, wafers, rods, or porous monoliths. The different resins in the system may be the same shapes or configurations (for example, the different resins may be spherical ion exchange beads), or may be different (for example, the mixed bed resins may be composed of spherical ion exchange beads while the three-layer ion exchange resin stack is composed of fibres). Cation exchange resins, anion exchange resins, and mixed bed ion-exchange resins, as well as their configurations within an electrodeionization apparatus are discussed in US Patent Publication 2008/0073215 A1, which is incorporated herein by reference.

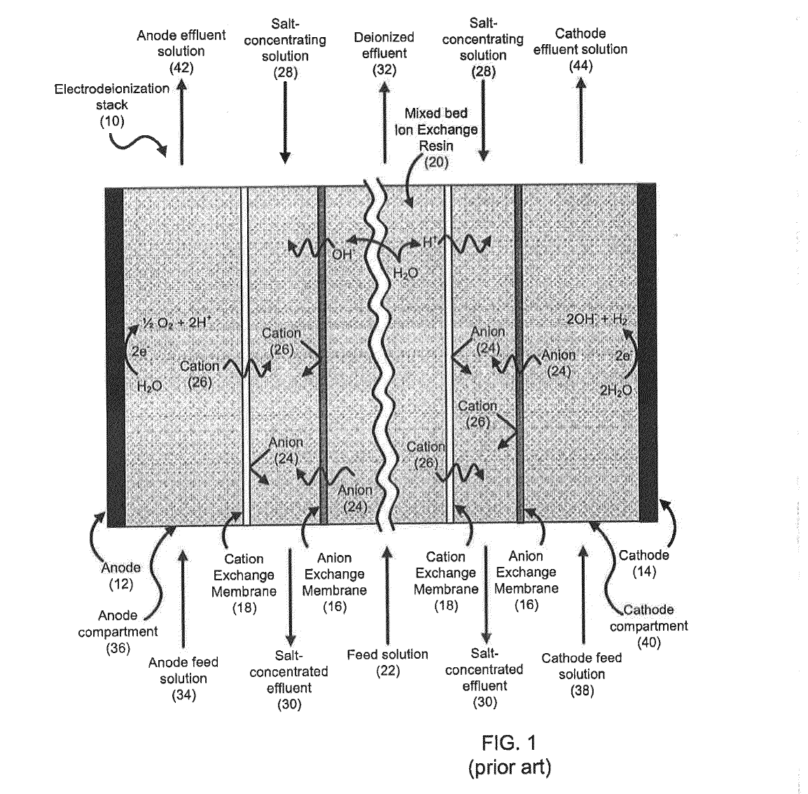

A simplified example of a traditional electrodeionization stack is illustrated in FIG. 1. Electrodeionization (EDI) stack (10) includes anode (12) and cathode (14), as well as alternating pairs of anion-exchange membrane (16) and cation-exchange membrane (18). Mixed bed ion exchange resin (20) is located between the membranes (16), (18). Although the electrodeionizing stack illustrated in FIG. 1 shows two pairs of ion exchange membranes, defining two salt-concentrating compartments and two partial deionizing compartments, an electrodeionization stack typically includes a plurality of pairs of ion exchange membranes (16), (18) that define a plurality of salt-concentrating compartments alternating with a plurality of deionizing compartments. The two curving lines in the center of the stack in FIG. 1 (and similarly in the other figures) indicates that the EDI stack may have any number of pairs of anion exchange membranes and cation exchange membranes, forming alternating salt-concentrating compartments and deionizing compartments, in the area between the two curving lines. The term mixed bed ion exchange resin (20) is used because a mixed bed is an exemplary configuration for providing multiple points of contact between anion and cation exchange resins. However, the term mixed bed exchange resin (20) is meant to include other possible configurations or anion and cation exchange resins, for example in layers, as islands or in a checkerboard configuration.

In operation, the electrodeionization stack (10) accepts a feed solution (22), which includes anions (24) and cations (26). The anions (24) and the cations (26) in the feed solution (22) are removed from the feed solution (22), and the anion and cation ion-exchange resins (20) generate H⁺ and OH⁻ ions which aid in collection of the impurity anions (24) and the cations (26) through normal ion exchange reactions at the anion and cation ion exchange resins. Although FIG. 1 illustrates ionization of a single water molecule producing one H⁺ ion which migrates across the cation exchange membrane and one OH⁻ ion which migrates across the anion exchange membrane, it would be understood that this is representative of the ionization of multiple water molecules across the plurality of the salt-concentrating and deionizing compartments.

An applied electric potential difference induces the anions (24) to move towards the anode (12), through the anion-exchange membrane (16), and be concentrated in salt concentrating solution (28). Similarly, the cations (26) are induced to move towards the cathode (14), through the cation-exchange membrane (18), and be concentrated in the salt concentrating solution (28). The salt concentration solution (28) is dispensed from the electrodeionization stack (10) as salt-concentrated effluent (30). The salt concentrating solution (28) may be feed solution (22) or a mixture of feed solution (22) with a recirculated portion of the salt-concentrated effluent (30). In this manner, the feed solution (22) is reduced in ion concentration, and is dispensed from the electrodeionization stack (10) as deionized effluent (32).

The anion and cation ion-exchange resin (20) aids in the migration of the cations (26) and the anions (24) by moving the cations (26) along adjacent beads of cation-exchange resin towards the cathode (14), and by moving the anions (24) to adjacent anion-exchange resin towards the anode (12).

As the anions (24) and the cations (26) are removed from the feed solution (22), the conductivity of the feed solution (22) decreases and the applied electrical potential splits water at the surface of the resin (20), producing H⁺ and OH⁻ ions, which regenerate the cation- and anion-exchange resins (20), which can be arranged in the deionization compartment as a mixed bed or a separated bed ion-exchange resin (20).

In order to carry the current across the electrodeionization stack (10), an anode feed solution (34) is provided to anode compartment (36) and which flows past the anode (12), and a cathode feed solution (38) is provided to cathode compartment (40) and which flows past the cathode (14). The anode and cathode feed solutions (34 and 38) include ions to carry the current. The anode and cathode feed solutions (34 and 38) may be of the same composition as the feed solution (22), or may be of a different composition from the feed solution. The anode and cathode feed solutions (34 and 38) are delivered from the electrodeionization stack (10) as anode effluent solution (42) and cathode effluent solution (44), respectively.

Production of OH⁻ ions occurs at the cathode (14) in order to maintain a charge balance in the cathode feed solution (36). Similarly, production of H⁺ ions occurs at the anode (12) in order to maintain a charge balance in the anode feed solution (34). The production of OH⁻ ions increases the likelihood of scaling since the OH⁻ ions can react with multivalent cations, such as Ca²⁺ and Mg²⁺, present in the cathode feed solution (36), resulting in, for example, precipitation of calcium carbonate (CaCO₃) and magnesium hydroxide (Mg(OH)₂) scales.

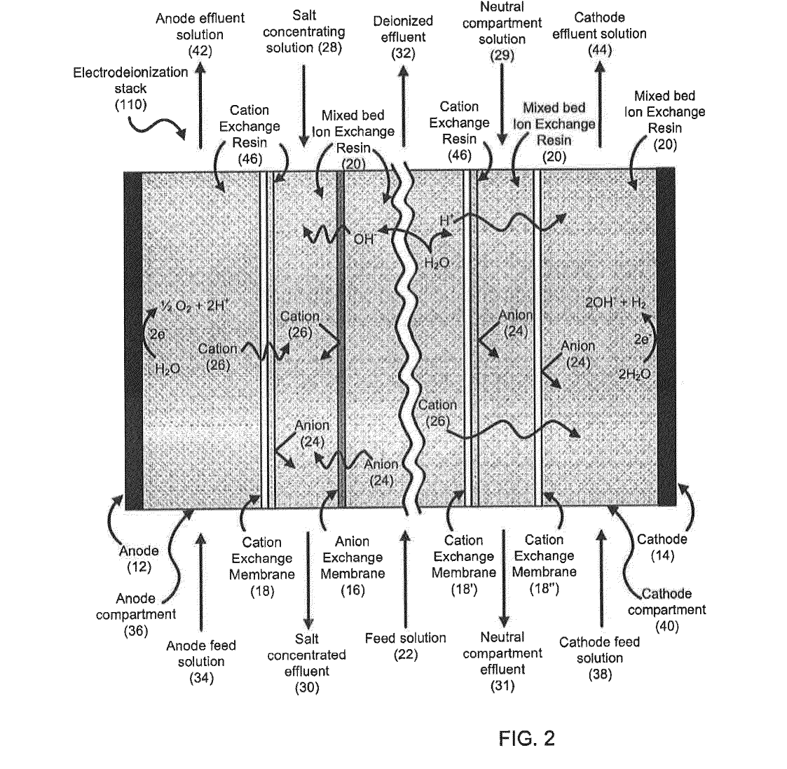

FIG. 2. shows a new electrodeionizing stack (110). The portion of the electrodeionizing stack illustrated in FIG. 2 shows two electrode compartments, one salt-concentrating compartment, one neutral compartment and two partial deionizing compartments, it would be understood that the electrodeionization stack would typically include additional pairs of ion exchange membranes that define a plurality of salt-concentrating compartments alternating with a plurality of deionizing compartments in the area between the two curving lines running through the center of the stack. The plurality of deionizing compartments provide the deionized effluent, while the plurality of salt-concentrating compartments provide the salt-concentrated effluent. A neutral compartment, defined between the two cation exchange membranes (18′), (18″), or in other figures between any pair of cation exchange membranes or pair of anion exchange membranes, is said to receive neutral compartment solution (29) (which may be salt-concentrating solution (28), or feed solution (22); and where the salt-concentrating solution (28) may be feed solution (22)) and to discharge neutral compartment effluent (31). The neutral compartment effluent (31) may be salt-concentrated effluent (30) even through a neutral compartment does not concentrate salts because the inlet and outlet of the neutral compartment may be connected in parallel with inlets and outlets of the salt concentrating cells within a stack. Alternatively, a neutral compartment may have a separate inlet and outlet and be fed a distinct neutral compartment feed. A reference to a salt concentrating compartment in the description of a figure typically indicates the specific salt concentrating compartment visible in the figure, unless the context of the references suggests that all of the salt concentrating compartments are being described.

The electrodeionization stack (110) includes the anode (12) and the cathode (14), as well as the anion-exchange membrane (16) and the cation-exchange membranes (18, 18′ and 18″). The anion exchange membrane (16) and the cation exchange membrane (18) define a first salt-concentrating compartment. The pair of cation exchange membranes (18′ and 18″) define a neutral compartment.

The mixed bed ion-exchange resin (20) is located in: (i) a deionizing compartment that accepts the provided feed solution (22); (ii) in the salt-concentrating compartment and the neutral compartment; and (iii) the cathode compartment (40). Cation exchange resin (46) is packed in the anode compartment (36), as well as on the cathode side of the cation exchange membranes (18) and (18′).

The cation exchange resin (46) is located on the cation exchange membranes (18) and (18′) because salt concentrating solution (28) may include bicarbonate anions. This bicarbonate is turned into carbon dioxide when exposed to acidic conditions, for example on exposure to the H⁺ ions migrating through the cation exchange membranes (18) and (18′) towards the cathode (14). This generated carbon dioxide is undesirable since it reduces the resistivity of the solution. The cation exchange resin (46) on the cathode side of the cation exchange membranes (18) and (18′) acts as a barrier to the bicarbonate since it does not aid in the migration of the bicarbonate, thereby reducing buildup of carbon dioxide on the cation exchange membranes (18) and (18′).

In operation, the electrodeionization stack (110) accepts the provided feed solution (22), which includes the anions (24) and the cations (26). The anions (24) and the cations (26) in the feed solution (22) are removed from the feed solution (22) and the mixed bed ion-exchange resin (20) generates H⁺ and OH⁻ ions which aid in migration of the anions (24) and the cations (26). Although FIG. 2 illustrates ionization of a single water molecule producing one H⁺ ion which migrates across the cation exchange membranes (18′) and (18″) and one OH⁻ ion which migrates across the anion exchange membrane (16), it would be understood that this is representative of the ionization of multiple water molecules across the plurality of the salt-concentrating and deionizing compartments.

An applied electric potential difference induces the anions (24) to move towards the anode (12), and induces the cations (26) to move towards the cathode (14).

Anions (24) in the feed solution move through the anion-exchange membrane (16), and are concentrated in the salt concentrating solution (28) which flows through the salt concentrating compartment. Cations (26) in the anode feed solution (34) move through the cation-exchange membrane (18), and are also concentrated in the salt concentrating solution (28) which flows through the salt concentrating compartment.

The cations (26) in the feed solution (22) are induced to move towards the cathode (14), through the cation-exchange membranes (18′ and 18″) and are concentrated in the cathode compartment (40). Charge balance in the cathode compartment (40) is maintained through the production of OH⁻ at the cathode.

The salt concentrating solution (28) flows through the salt concentrating compartment and the neutral compartment and is dispensed from the electrodeionization stack (110) as salt-concentrated effluent (30). In this manner, the feed solution (22) is reduced in ion concentration, and is dispensed from the electrodeionization stack (110) as deionized effluent (32).

The mixed bed ion-exchange resin (20) aids in the migration of the cations (26) and the anions (24) by moving the cations (26) along adjacent beads of cation-exchange resin towards the cathode (14), and by moving the anions (24) to adjacent anion-exchange resin towards the anode (12). The cation exchange resin (46) in the cathode compartment aids in the migration of the cations (26) by moving the cations (26) along adjacent beads of cation-exchange resin towards the cathode (14).

As the anions (24) and the cations (26) are removed from the feed solution (22), the conductivity of the feed solution (22) decreases and the applied electrical potential splits water at the surface of the resin (20), producing H⁺ and OH⁻ ions, which regenerate the cation- and anion-exchange resins which make up the mixed bed ion-exchange resin (20).

In order to carry the current across the electrodeionization stack (110), the anode feed solution (34) is provided to the anode compartment (36) and which flows past the anode (12), and the cathode feed solution (38) is provided to the cathode compartment (40) and which flows past the cathode (14). The anode and cathode feed solutions (34 and 38) include ions to carry the current. The anode feed solution (34) may be of the same composition as the feed solution (22), or may be of a different composition from the feed solution (22). The anode feed solution (34) is delivered from the anode compartment (36) as the anode effluent solution (42). The cathode feed solution (38) is delivered from the cathode compartment (40) as the cathode effluent solution (44).

In further EDI systems to be described below, and the methods which are implemented by these systems, an acidic anode effluent solution flows into the cathode compartment. The acidic anode effluent solution may neutralize the OH⁻ ions produced at the cathode and reduce scaling at the cathode.

The system may additionally be adapted to retain cations, such as H⁺ ions (for example hydronium ions), in the anode effluent solution in order to increase the acidity of the anode effluent solution so that the anode effluent solution can better neutralize the OH⁻ ions produced at the cathode.

The system may additionally include mixed bed ion exchange resin in the electrode compartments, as illustrated in FIG. 2. There may also be at least one two-layer ion exchange resin stack, at least one three-layer ion exchange resin stack, or a combination of two-layer and three-layer ion exchange resin stacks.

A three-layer ion exchange resin stack is made up of a layer of cation exchange resin, a layer of anion exchange resin, and a mixed bed ion-exchange resin located between the cation and the anion exchange resins. Three-layer ion exchange resin stacks are positioned with the cation exchange resin on the anode side, and the anion exchange resin on the cathode side.

A two-layer ion exchange resin stack is made up of a layer of anion exchange resin, and a mixed bed ion-exchange resin. Two-layer ion exchange resin stacks are positioned with the cation exchange resin on the anode side, and the anion exchange resin on the cathode side.

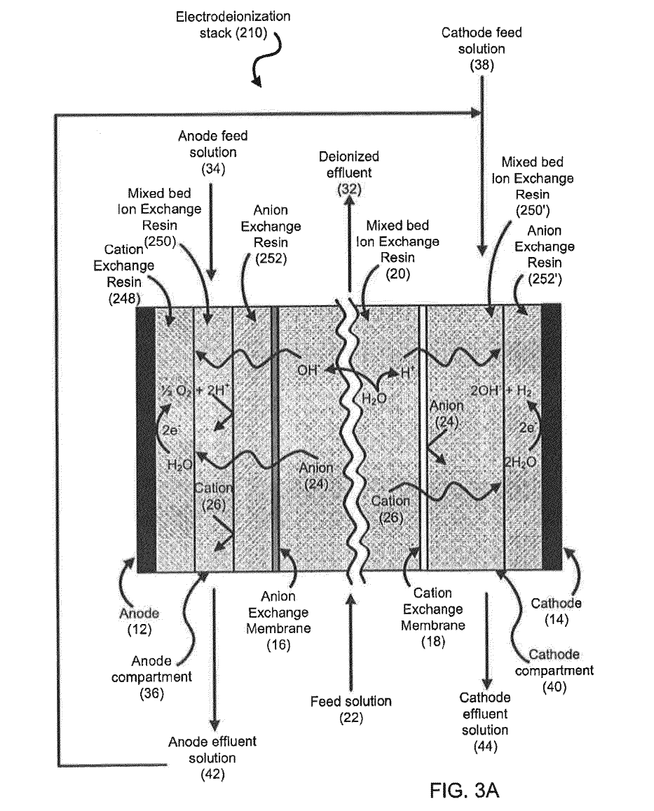

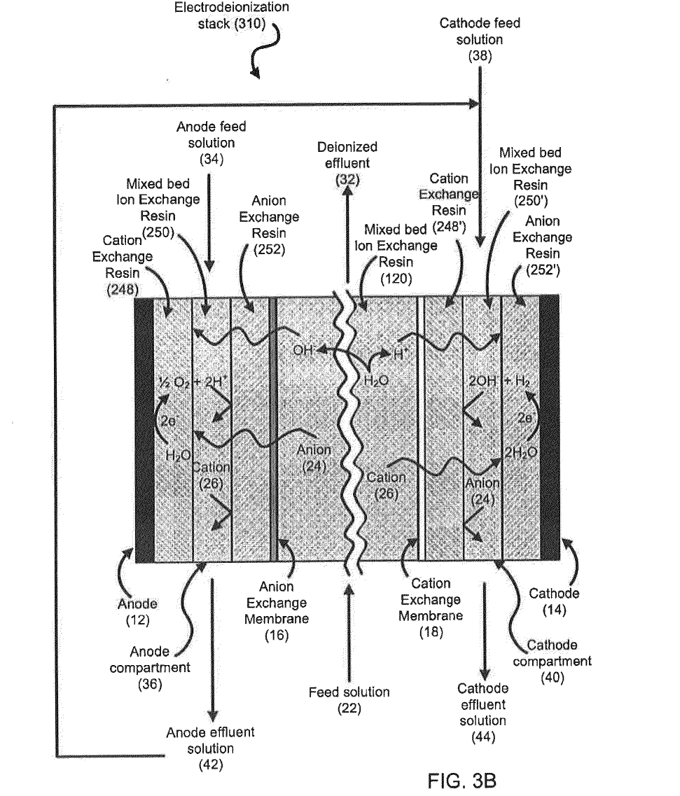

The electrodeionization stack (110) in FIG. 3A includes the anode (12) and the cathode (14), as well as an anion-exchange membrane (16) and a cation-exchange membrane (18). Although the electrodeionizing stack illustrated in FIG. 3A shows two partial deionizing compartments, it would be understood that the electrodeionization stack may include a plurality of pairs of ion exchange membranes that define a plurality of salt-concentrating compartments alternating with a plurality of deionizing compartments in the area between the pair of curving lines in the center of the stack. The plurality of deionizing compartments provide the deionized effluent, while the plurality of salt-concentrating compartments provide the salt-concentrated effluent.

Mixed bed ion-exchange resin (20) is located in the deionizing compartment that accepts the provided feed solution (22).

The electrodeionization stack (110) includes a three-layer ion exchange resin stack in the anode compartment (36) and a two-layer ion exchange resin stack in the cathode compartment (40). The three-layer ion exchange resin stack is made up of cation exchange resin (248), mixed bed ion-exchange resin (250) and anion exchange resin (252), with the cation exchange resin (248) on the anode side, and the anion exchange resin (252) on the cathode side. The two-layer ion exchange resin stack in the cathode compartment (40) is similarly made up of the mixed bed ion-exchange resin (250′) and the anion exchange resin (252′), with the anion exchange resin (252′) on the cathode side of the mixed bed ion-exchange resin (250′).

The three-layer ion exchange resin stack in the anode compartment (36) helps move cations (specifically hydronium ions) and anions towards the center of the anode compartment (36) by: (i) facilitating the movement of cations in the anode compartment (36) towards the cathode using the cation exchange resin (248) and the mixed bed ion-exchange resin (250), but hindering the movement of the cations towards the cathode once the cations reach the anion exchange resin (252); and (ii) facilitating the movement of anions in the anode compartment (36) towards the anode using the anion exchange resin (252) and the mixed bed ion-exchange resin (250), but hindering the movement of the anions towards the anode once the anions reach the cation exchange resin (248). In this manner the cations and anions concentrated in the center of the anode compartment (36) where the linear velocity of the flow of the anode feed solution (34) is greater.

In a similar manner, the two-layer ion exchange resin stack in the cathode compartment (40): (i) facilitates the movement of cations in the cathode compartment (40) towards the cathode using the mixed bed ion-exchange resin (250′), but hinders the movement of the cations towards the cathode once the cations reach the anion exchange resin (252′); and (ii) facilitates the movement of anions in the cathode compartment (40) towards the anode using the anion exchange resin (252′) and the mixed bed ion-exchange resin (250′). In this way, potentially scale forming ions are kept way from the surface of the cathode and instead concentrated in the center of the cathode compartment where they are exposed to acidic anode effluent at a relatively high flow velocity.

A variant of the electrodeionization stack (210) is illustrated in FIG. 3B electrodeionization stack (310). The electrodeionization stack (310) includes a three-layer ion exchange resin stack in the cathode compartment (40) instead of a two-layer ion exchange resin stack.

In operation, the electrodeionization stacks (210) and (310) accept the provided feed solution (22), which includes anions (24) and cations (26). The anions (24) and the cations (26) in the feed solution (22) are removed from the feed solution (22) by the mixed bed ion-exchange resin (20) and the mixed bed ion-exchange resin (20) generates H⁺ and OH⁻ ions which aid in migration of the anions (24) and the cations (26). Although FIGS. 3A and 3B illustrate ionization of a single water molecule producing one H⁺ ion which migrates across the cation exchange membrane (18) and one OH⁻ ion which migrates across the anion exchange membrane (16), it would be understood that this is representative of the ionization of multiple water molecules across the plurality of the salt-concentrating and deionizing compartments represented in the figures by the two partial deionizing compartments and the further pairs of anion and cation exchange membranes that would be located between them.

An applied electric potential difference induces the anions (24) to move towards the anode (12), through the anion-exchange membrane (16), and be concentrated in the anode feed solution (34) which flows through the anode compartment (36). Similarly, the cations (26) are induced to move towards the cathode (14), through the cation-exchange membrane (18), and be concentrated in the cathode feed solution (38) which flows through the cathode compartment (40). In this manner, the feed solution (22) is reduced in ion concentration, and is dispensed from the electrodeionization stacks (210) and (310) as deionized effluent (32).

As discussed above, the mixed bed ion-exchange resin (20) aids in the migration of the cations (26) and the anions (24) by moving the cations (26) along adjacent beads of cation-exchange resin towards the cathode (14), and by moving the anions (24) to adjacent anion-exchange resin towards the anode (12). As the anions (24) and the cations (26) are removed from the feed solution (22), the conductivity of the feed solution (22) decreases and the applied electrical potential splits water at the surface of the resin (20), producing H⁺ and OH⁻ ions, which regenerate the cation- and anion-exchange resins which make up the mixed bed ion-exchange resin (20).

The anode feed solution (34) is delivered from the anode compartment (36) as anode effluent solution (42). In contrast to the electrodeionization stack illustrated in FIG. 1, at least a portion of the anode effluent solution (42) is directed to the cathode feed solution (38). The anode effluent solution (42), and any additional distinct cathode feed solution (38), is delivered from cathode compartment (40) as cathode effluent solution (44). In some systems, no cathode feed solution (38) is added to the electrodeionizing stacks (210) and (310) and only the anode effluent solution (42) is used in the cathode compartment (40).

Without wishing to be bound by theory, it is believed that the electrodeionization stacks (210) and (310) reduce scaling at the cathode (14) by: (a) acidifying the solution in the cathode compartment (40) by using the acidic anode effluent solution to neutralize OH⁻ ions produced at the cathode; and (b) concentrating divalent cations, which react with the OH⁻ ions to form the precipitating scales, in an area of the cathode compartment (40) which has a greater flow rate than the flow rate adjacent to the cathode (14).

Similarly, it is believed that the electrodeionization stacks (210) and (310) reduce scaling at the anode (12) by concentrating divalent cations, which react with OH⁻ ions to form the precipitating scales, in an area of the anode compartment (36) which has a greater flow rate than the flow rate adjacent to the anode (12).

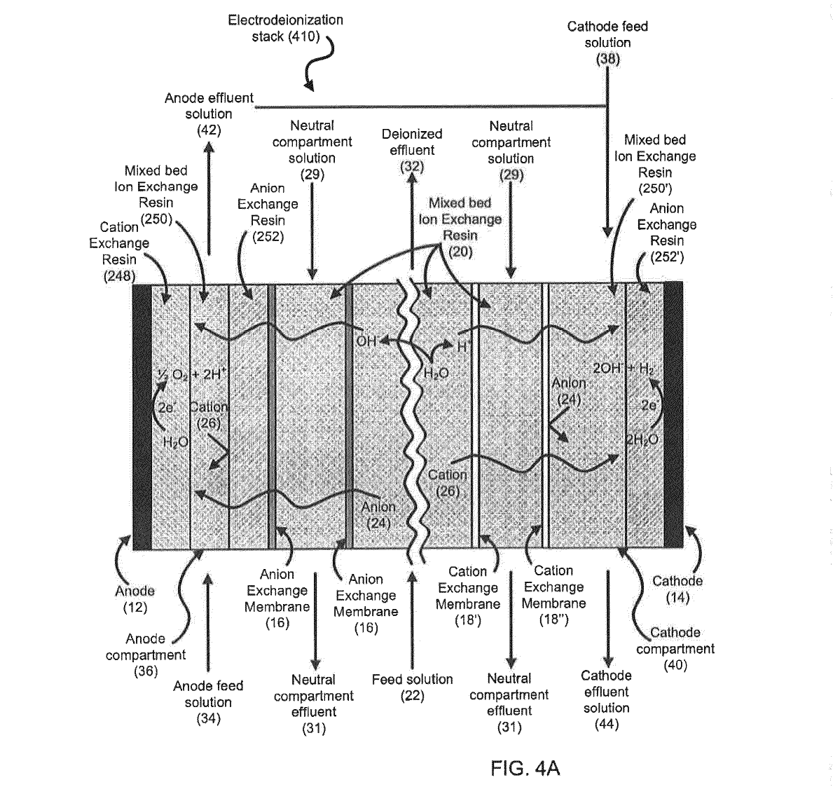

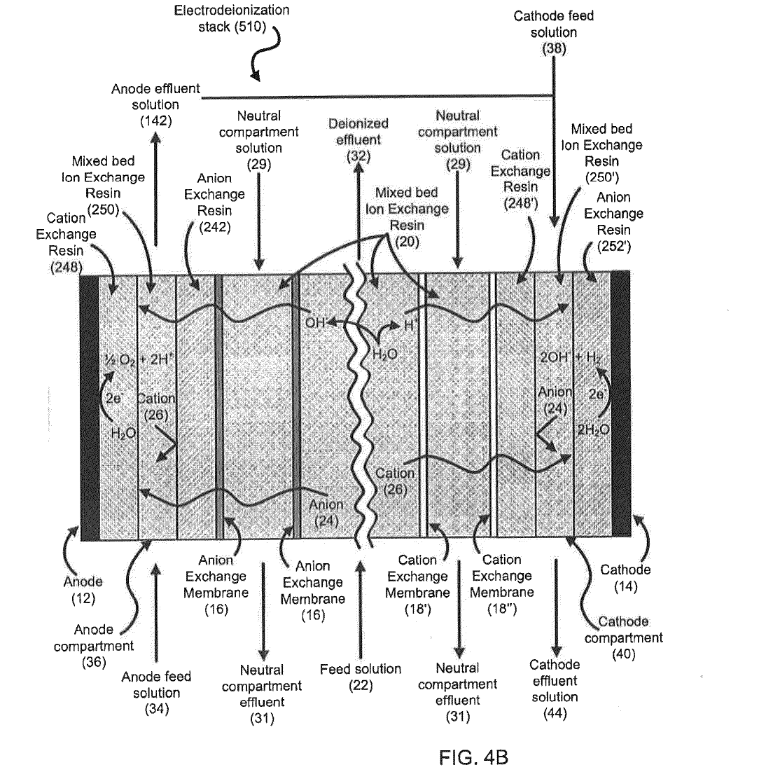

The electrodeionization stack (410) of FIG. 4A includes the anode (12) and the cathode (14), as well as a pair of the anion-exchange membranes (16) and a pair of the cation-exchange membranes (18′ and 18″). Although the electrodeionizing stack illustrated in FIG. 4A shows two partial deionizing compartments and a pair of neutral compartments, it would be understood that the electrodeionization stack may include a plurality of pairs of ion exchange membranes that define a plurality of salt-concentrating compartments alternating with a plurality of deionizing compartments in the area between the pair of curved lines in the center of the stack. The plurality of deionizing compartments provide the deionized effluent, while the plurality of salt-concentrating compartments provide the salt-concentrated effluent.

Mixed bed ion-exchange resin (20) is located in the deionizing compartments, which accept the provided feed solution (22). The pair of anion exchange membranes (16) define a first neutral compartment. The pair of cation exchange membranes (18′ and 18″) define a second neutral compartment. The pair of anion exchange membranes and the pair of cation exchange membranes act as barriers and allow the hydraulic flow parameters of the neutral compartments to be modified independently from the hydraulic flow parameters of the deionizing compartments, the anode feed compartment and the cathode feed compartment. Gasses that may be created in the electrode compartments, for example chlorine or hydrogen, are also retained in the electrode compartments. These gasses can then be removed by treating the electrode effluent streams.

Mixed bed ion-exchange resin (20) is located in the first and the second neutral compartments. Alternatively, (i) anion exchange resin may be located in the first neutral compartment, (ii) cation exchange resin may be located in the second neutral compartment, or (iii) anion exchange resin may be located in the first neutral compartment and cation exchange resin may be located in the second neutral compartment.

The electrodeionization stack (410) includes a three-layer ion exchange resin stack in the anode compartment (36) and a two-layer ion exchange resin stack in the cathode compartment (40). The three-layer ion exchange resin stack is made up of cation exchange resin (248), mixed bed ion-exchange resin (250) and anion exchange resin (252), with the cation exchange resin (248) on the anode side, and the anion exchange resin (252) on the cathode side. The two-layer ion exchange resin stack in the cathode compartment (40) is similarly made up of the mixed bed ion-exchange resin (250′) and the anion exchange resin (252′), with the anion exchange resin (252′) on the cathode side of the mixed bed ion-exchange resin (250′).

The three-layer ion exchange resin stack in the anode compartment (36) helps move cations and anions towards the center of the anode compartment (36) by: (i) facilitating the movement of cations in the anode compartment (36) towards the cathode using the cation exchange resin (248) and the mixed bed ion-exchange resin (250), but hindering the movement of the cations towards the cathode once the cations reach the anion exchange resin (252); and (ii) facilitating the movement of anions in the anode compartment (36) towards the anode using the anion exchange resin (252) and the mixed bed ion-exchange resin (250), but hindering the movement of the anions towards the anode once the anions reach the cation exchange resin (248). In this manner the cations and anions concentrated in the center of the anode compartment (36) where the linear velocity of the flow of the anode feed solution (34) is greater.

In a similar manner, the two-layer ion exchange resin stack in the cathode compartment (40): (i) facilitates the movement of cations in the cathode compartment (40) towards the cathode using the mixed bed ion-exchange resin (250′), but hinders the movement of the cations towards the cathode once the cations reach the anion exchange resin (252′); and (ii) facilitates the movement of anions in the cathode compartment (40) towards the anode using the anion exchange resin (252′) and the mixed bed ion-exchange resin (250′).

A variant of the electrodeionization stack (410) is illustrated in FIG. 4B as electrodeionization stack (510). The electrodeionization stack (510) includes a three-layer ion exchange resin stack in the cathode compartment (40) instead of a two-layer ion exchange resin stack.

In operation, the electrodeionization stacks (410) and (510) accept the provided feed solution (22), which includes anions (24) and cations (26). The anions (24) and the cations (26) in the feed solution (22) are removed from the feed solution (22) by the mixed bed ion-exchange resin (20) and the mixed bed ion-exchange resin (20) generates H⁺ and OH⁻ ions which aid in migration of the anions (24) and the cations (26). Although FIGS. 4A and 4B illustrate ionization of a single water molecule producing one H⁺ ion which migrates across the cation exchange membranes (18′) and (18″) and one OH⁻ ion which migrates across the anion exchange membranes (16), it would be understood that this is representative of the ionization of multiple water molecules across the plurality of the salt-concentrating and deionizing compartments.

An applied electric potential difference induces the anions (24) to move towards the anode (12), through one or both of the pair of anion-exchange membranes (16), to be deposited in the neutral compartment solution (29) which flows through the first neutral compartment, in the anode feed solution (34) which flows through the anode compartment (36), or in both the neutral compartment solution (29) and the anode feed solution (34).

Similarly, the cations (26) are induced to move towards the cathode (14), through one or both of the pair of the cation-exchange membranes (18′ and 18″), and be deposited in the neutral compartment solution (29) which flows through the second neutral compartment, in the cathode feed solution (38) which flows through the cathode compartment (40), or in both the neutral compartment solution (29) and the cathode feed solution (38).

The water flowing through the neutral compartments may be dispensed from the electrodeionization stack (410) as neutral compartment effluent (31) with the salt-concentrated effluent from the salt-concentration compartments. The feed solution (22) is reduced in ion concentration, and is dispensed from the electrodeionization stacks (410) and (510) as deionized effluent (32).

As discussed above, the mixed bed ion-exchange resin (20) aids in the migration of the cations (26) and the anions (24) by moving the cations (26) along adjacent beads of cation-exchange resin towards the cathode (14), and by moving the anions (24) to adjacent anion-exchange resin towards the anode (12). As the anions (24) and the cations (26) are removed from the feed solution (22), the conductivity of the feed solution (22) decreases and the applied electrical potential splits water at the surface of the resin (20), producing H⁺ and OH⁻ ions, which regenerate the cation- and anion-exchange resins which make up the mixed bed ion-exchange resin (20).

The anode feed solution (34) is delivered from the anode compartment (36) as anode effluent solution (42). In contrast to the electrodeionization stack illustrated in FIG. 1, at least a portion of the anode effluent solution (42) is directed to the cathode feed solution (38). The mixture of the cathode feed solution (38) and anode effluent solution (42) is delivered from cathode compartment (40) as cathode effluent solution (44). In some systems, no cathode feed solution (38) is added to the electrodeionizing stacks (210) and (310) and only the anode effluent solution (42) is used in the cathode compartment (40).

Without wishing to be bound by theory, it is believed that the electrodeionization stacks (410) and (510) reduce scaling at the cathode (14) by: (a) acidifying the solution in the cathode compartment (40) by using the acidic anode effluent solution to neutralize OH⁻ ions produced at the cathode; and (b) concentrating divalent cations, which react with the OH⁻ ions to form the precipitating scales, in an area of the cathode compartment (40) which has a greater flow rate than the flow rate adjacent to the cathode (14).

Similarly, it is believed that the electrodeionization stacks (410) and (510) reduce scaling at the anode (12) by concentrating divalent cations, which react with OH⁻ ions to form the precipitating scales, in an area of the anode compartment (36) which has a greater flow rate than the flow rate adjacent to the anode (12) of the anode compartment (36).

The electrodeionization stacks (410) and (510) may optionally be modified to include cation exchange resin located on the cathode side of the cation exchange membrane (18′), and/or located on the cathode side of the cation exchange membranes that define the plurality of salt-concentrating compartments which alternate with the plurality of deionizing compartments. It may be advantageous to modify the electrodeionization stacks (410) and (510) in such a manner because the salt concentrating solution (28) may include bicarbonate anions. This bicarbonate is turned into carbon dioxide when exposed to acidic conditions, for example on exposure to the H⁺ ions migrating through the cation exchange membrane (18′) towards the cathode (14). This generated carbon dioxide is undesirable since it reduces the resistivity of the solution. The cation exchange resin on the cathode side of the cation exchange membrane (18′) acts as a barrier to the bicarbonate since it does not aid in the migration of the bicarbonate, thereby reducing buildup of carbon dioxide on the cation exchange membranes (18′) which is adjacent to the deionizing compartment.

The electrodeionization stacks (410) and (510) may optionally be modified to remove one of the pair of anion exchange membranes (16) thereby resulting in an electrodeionization stack having a single neutral compartment adjacent to the cathode compartment (40).

Without wishing to be bound by theory, it is believed that the electrodeionization stacks (410) and (510) reduces scaling at the cathode (114) by: (a) acidifying the solution in the cathode compartment (140) using the acidic anode effluent solution to neutralize OH⁻ ions produced at the cathode; and (b) concentrating divalent cations, which react with the OH⁻ ions to form the precipitating scales, in an area of the cathode compartment (140) which has a greater flow rate than the flow rate adjacent to the cathode (114).

Similarly, it is believed that the electrodeionization stack (110) reduces scaling at the anode (112) by concentrating divalent cations, which react with OH⁻ ions to form the precipitating scales, in an area of the anode compartment (136) which has a greater flow rate than the flow rate adjacent to the anode (12).

This written description uses examples to help disclose the invention, including the best mode, and also to enable any person skilled in the art to practice the invention, including making and using any devices or systems and performing any incorporated methods. Alterations, modifications and variations can be effected to the particular examples by those of skill in the art without departing from the scope of the invention. The patentable scope of the invention is defined by the claims, and may include other examples that occur to those skilled in the art.

What is claimed is:

1. An electrodeionization stack for deionizing a feed solution, the electrodeionization stack comprising:
a cathode and an anode;
a first ion exchange membrane;
a second ion exchange membrane;
a salt concentrating compartment and a deionizing compartment between the first and second ion exchange membranes;
an ion exchange resin located in the deionizing compartment;
a cathode compartment between the first ion exchange membrane and the cathode, the cathode compartment adapted to accept a cathode feed solution and dispense a cathode effluent solution;
an anode compartment between the second ion exchange membrane and the anode, the anode compartment adapted to accept an anode feed solution and dispense an acidic anode effluent solution;
a transfer system adapted to flow acidic anode effluent solution into the cathode feed solution;
the deionizing compartment adapted to accept the feed solution and dispense a deionized effluent on application of an applied electric potential difference.

2. The electrodeionization stack according to claim 1, wherein the anode compartment is bounded by the anode and an anion exchange membrane.

3. The electrodeionization stack according to claim 2, wherein the second ion exchange membrane is an anion exchange membrane and the second ion exchange membrane is a boundary of the anode compartment or a boundary of a neutral compartment adjacent the anode compartment.

4. The electrodeionization stack according to claim 1, further comprising:
a first three-layer ion exchange resin stack positioned in the anode compartment;
wherein the three-layer ion exchange resin stack is made up of a layer of cation exchange resin, a layer of anion exchange resin, and a mixed bed ion-exchange resin located between the cation and the anion exchange resins;
and wherein the three-layer exchange resin stack is positioned with the cation exchange resin on the anode side, and the anion exchange resin on the cathode side.

5. The electrodeionization stack according to claim 1, further comprising a second three-layer ion exchange resin stack positioned in the cathode compartment;
wherein the three-layer ion exchange resin stack is made up of a layer of cation exchange resin, a layer of anion exchange resin, and a mixed bed ion-exchange resin located between the cation and the anion exchange resins;
and wherein the three-layer exchange resin stack is positioned with the cation exchange resin on the anode side, and the anion exchange resin on the cathode side.

6. The electrodeionization stack according to claim 1, further comprising a two-layer ion exchange resin stack positioned in the cathode compartment;
wherein the two-layer ion exchange resin stack is made up of a layer of anion exchange resin, and a layer of mixed bed ion-exchange resin, wherein the two-layer exchange resin stack is positioned with the anion exchange resin on the cathode side of the mixed bed ion-exchange resin.

7. The electrodeionization stack according to claim 3 comprising a first neutral compartment adjacent the anode compartment.

8. The electrodeionization stack according to claim 7, wherein anion exchange resin or mixed bed ion-exchange resin is located in the first neutral compartment.

9. The electrodeionization stack according to claim 1, further comprising a fourth ion exchange membrane positioned on the cathode side of the first ion exchange membrane, the first and fourth ion exchange membranes defining a second neutral compartment.

10. The electrodeionization stack according to claim 9, wherein the first and fourth ion exchange membranes are both cation exchange membranes.

11. The electrodeionization stack according to claim 10, wherein cation exchange resin or mixed bed ion-exchange resin is located in the second neutral compartment.

12. The electrodeionization stack according to claim 10, wherein mixed bed ion-exchange resin is located in the second neutral compartment and the second neutral compartment further comprises cation exchange resin on the cathode side of the first ion exchange membrane.

13. A method of producing a deionized effluent from a feed solution which comprises anions and cations, the method comprising:
providing the feed solution to a deionizing compartment of an electrodeionizing stack, the electrodeionizing stack comprising an anode and a cathode;
providing an anode feed solution to an anode compartment of the electrodeionizing stack;
providing a cathode feed solution to a cathode compartment of the electrodeionizing stack;
applying an electric potential difference across the electrodeionizing stack to:
(i) induce the cations in the feed solution to move through a first ion exchange membrane towards the cathode, and induce the anions in the feed solution to move through a second ion exchange membrane towards the anode, thereby producing the deionized effluent; and
(ii) generate H⁺ ions in the anode compartment;
dispensing the deionized effluent from the deionizing compartment;
dispensing an anode effluent solution from the anode compartment; and
transferring at least a portion of the anode effluent solution into the electrodeionizing stack as the cathode feed solution, or as a mixture with the cathode feed solution.

14. The method according to claim 13, wherein the H+ ions generated in the anode compartment are retained in the anode compartment by an anion exchange membrane.

15. The method according to claim 13, wherein the cations are inhibited from migrating towards the cathode by the presence of anion exchange resin in the cathode compartment.

16. The method according to claim 15, wherein inhibiting the cations from migrating concentrates the cations in an area of the cathode compartment which has a greater flow rate than the flow rate adjacent to the cathode.

17. The method according to claim 13, wherein the anions are inhibited from migrating towards the anode by the presence of cation exchange resin in the anode compartment.

18. The method according to claim 17, wherein inhibiting the anions from migrating concentrates the anions in an area of the anode compartment which has a greater flow rate than the flow rate adjacent to the anode.

19. The method according to claim 13 wherein at least a portion of the cations are divalent cations.
